(19) United States
(12) Patent Application Publication
(10) Pub. No.: US 2004/0133451 A1
(43) Pub. Date: Jul. 8, 2004

(54) Anonymous e-health commerce

(76) Inventor: Peter Kleinschmidt, Munich (DE)

Correspondence Address: HARNESS, DICKEY & PIERCE, P.L.C., P.O.BOX 8910, RESTON, VA, 20195, US

(21) Appl. No.: 10/681,270

(22) Filed: Oct. 9, 2003

(30) Foreign Application Priority Data
Oct. 9, 2002 (DE) DE 102 47 153.3

(51) Int. Cl. G06F 17/60

(52) U.S. Cl. 705/2; 705/26

(57) ABSTRACT

An e-commerce device is for discretion-critical transactions, particularly on the Internet, having a personal electronic web health log, for storing, editing and using personal health data for a user. The device includes a data interface which can be used to set up a communication link to contracting parties when required in order to transfer data to them at least intermittently from the health log, there being a local health log on the user's computer with prestructured electronic forms for inputting the personal health data. Also, a converter is included, actuated by way of selection schemes and including data filters, for producing encrypted data. This may be anonymous, so that they do not permit any inferences about the user's identity. It includes an e-commerce platform for providers of health products and health services and/or a marketplace connected to such providers, preferably in the form of an Internet forum, having a database which a multiplicity of preproduced schemes (templates) which are organized according to medical questions and can be requested by the user. This is done in order to transfer encrypted data, selected on the basis of a template, for the user together with the template to the provider for the purpose of submitting tenders to the user on the basis of his medical question.

The present application hereby claims priority under 35 U.S.C. §119 on German patent application number DE 102 47 153.3 filed Oct. 9, 2002, the entire contents of which are hereby incorporated herein by reference.

### FIELD OF THE INVENTION

The invention generally relates to an e-commerce device for discretion-critical transactions, particularly on the Internet, preferably, a personal electronic web health log, for storing, editing and using personal health data for a user. It preferably includes a data interface which can be used to set up a communication link to contracting parties when required in order to transfer data to them at least intermittently from the health log, there being a local health log on the user's computer with pre-structured electronic forms for inputting the personal health data, and also a converter, actuated by use of selection schemes, and including data filters, for producing encrypted data, which may be anonymous, so that they do not permit any inferences about the user's identity.

### BACKGROUND OF THE INVENTION

Patients and health-conscious consumers currently do not have a safe and guaranteed way of discrete electronic access to their sensitive health data from all locations. In particular, they cannot make partial data records available to third parties in the health market at will, either anonymously or in relation to their own person, for the purpose of purchasing health-promoting products and services. This would be enormous progress in a consumer-oriented health market which uses the advantages of the Internet, however.

Before the Internet existed, the problem did not arise, since data communication was also not possible. In state-regulated health systems, the problem of communicating patient data has been discussed for more than 5 years on committees set up specifically for the purpose (e.g. the ATG and the ZTG in the Federal Republic of Germany), and there is no prospect of a networking solution. The rights to the data and the options for action by the parties involved in the health system are complicatedly regulated by a great variety of laws, which also differ nationally.

Thus, it is currently not even possible to regulate the data traffic between the institutions involved in the health service on a standard basis. There is even less prospect, it seems, of involving the patient, which would be highly desirable from a medical point of view.

At the present time, a card (health pass) storing the most important data locally now appears to be in the process of becoming accepted in Germany. Not all countries have such a highly regulated health market. The currently known techniques use a private key infrastructure (PKI) which allows secure transmission of information between authenticated parties. Identification of the parties involved and the existence of central directories give rise to two drawbacks: firstly, the patient is refused anonymous and soft transaction and consultancy developments. Secondly, the patient rightly feels that he is a glass person to state-controlled institutions.

The patent application DE 101 26 138.1-53 “Sabotage-proof and censorship-resistant personal electronic health file” proposes a way of allowing patient files to be stored securely and untraceably on the Internet in data capsules. This technique is also useful for implementing the present invention, but is not sufficient to solve the problem posed. Solutions also exist (e.g. for clinical studies) which involve the use of anonymous patient data. The data are not made available to the patient, however.

Besides the regulated health service, there is a private economic interest in selling and purchasing products and services which maintain and increase health. The area between illness, health and welfare is fluent in this case. “Health portals” providing health services are known. They are based on the same problem in principle. Of particular interest are services which turn to healthy people. The demands on privacy, that is to say on protection of personality, are likewise high in this context. The legal questions of data ownership and liability for false information can be assessed in an entirely different manner in this context, however, and are more in line with the traditions of e-commerce.

In addition, appealing advantageous solutions for business processes could be adopted from the field of e-commerce, such as worldwide person-to-person auctions for objects (for example eBay) or reverse bidding. Technical solutions relating to these methods can be found on the Internet (e.g.: www.tradepath.com). Nevertheless, no approaches to this can be found in the health service, because e-commerce currently also does not have any methods which satisfy the increased demands on discretion of personal health data. Furthermore, for negotiating health services, there are no computer-processed terms and quantifications from the longstanding health history of patients.

### SUMMARY OF THE INVENTION

An embodiment of the invention is therefore based on an object of designing an e-commerce device such that subsequent development and processing of discretion-critical transactions on the Internet specifically for anonymous business processes in the extramedical and paramedical health market is possible in a simple manner and while maintaining all aspects of data security, where a user can purchase health services and products from a wide variety of providers according to his personal requirements on the basis of the personal health log managed on his computer.

An embodiment of the invention achieves an object by virtue of an e-commerce device being characterized by an e-commerce platform for providers of health services and/or a marketplace connected to such providers, preferably in the form of an Internet forum, having a database with a multiplicity of preproduced schemes (templates) which are organized according to medical questions and can be requested by the user, in order to transfer encrypted data, selected on the basis of a template, for the user together with the template to the providers or the marketplace for the purpose of submitting tenders to the user on the basis of his medical question.

To be able to pick up health tenders directly from providers or else anonymously via a marketplace or via a broker, who is in turn connected to providers, novelty of an embodiment of the present invention is, inventively, a template database held with the providers or the broker which contains a catalog which is based on simple questions which even a layman can understand relating to his state of health or his particular health consultancy and treatment desires. Thus, the user can look for a template which is matched to his respective inquiry and can download it onto his computer in order to use the selection scheme corresponding to the template.

That is to say, he can use a data filter for selecting particular subgroups from the various stored health data, to load and possibly to encrypt just those data from his personal health log which are required for answering the question on which the template is based. Only these filtered data are transferred, together with the template, either to the broker or directly to the providers or to an anonymous Internet marketplace, where the various health providers then ultimately effect access in order to present a tender which corresponds to the inquiry.

By way of example, the user may be a diabetic and cannot tolerate particular ways of treatment or particular products. First of all, he has selected a template from the broker or from a provider on the basis of this problem. Using this template as a filter scheme, the necessary data with sole importance for answering these questions are taken from his personal health log and are made anonymous, and are sent to his broker or to a marketplace or to a health provider with the template for the purpose of indicating tenders. Depending on how the question has been put, he receives the tenders either directly from the provider or—as ought to be the norm in practice—via a broker who manages the user data and forwards inquiries therein to the providers in anonymous form, so that the providers can in turn forward tenders to the user only via the broker.

In this case, the templates naturally need to be structured according to the forms in the health log, or else the template databases are provided with a configuration device for matching the templates to the form structure in the user's health log. In the latter case, user inquiries relating to templates involve the structure of the health log naturally being sent as well, so that the template database can return correspondingly structured templates. The fact that this naturally works only for a few form structures is obvious, and therefore a few form structures need to be used as standard in order to be able to operate the inventive system.

In one development of an embodiment of the invention, provision can be made for the brokers, or the providers, to be provided with call centers, particularly for template consultancy. Thus, with more complex questions, in which the catalog which can be called up from the template databases is too complicated as a selection criterion for a medically untrained user, independent advice can be given regarding which template, that is to say which data filter, appears particularly suitable.

Contractual modules with the individual users of the inventive health system are used to determine the scope and to regulate the processing, including the billing, for the individual transactions between users, brokers and providers.

In another refinement of the invention, the provider stations can be provided with a service module in which analysis and advice modules, in conjunction with databases and an expert system, propose particularly effective advice and products on the basis of an analysis of the anonymous health data profiles and the inquiry template. In this case, such a service module can additionally contain a connection to human experts for the purpose of checking the automatically created tenders to the user.

Expediently, a broker station includes a customer (user) manager in order to forward inquiries from the users anonymously to particular marketplaces or providers and in order to transfer the tenders, which are preferably anonymous in terms of the provider names, to the users.

A specific way in which this processing takes place is largely dependent on the individual case and can be modified as desired. Thus, in principle, provision can be made for the provider never to come into direct contact with the user himself, but rather for the broker always to be in between them, not just on account of the details being kept anonymous, but rather also in order to filter and assess the multiplicity of possible provider tenders, so that the user is not showered with an overwhelming diversity of tenders from which he ultimately can no longer make a selection himself. Alternatively, it is possible for the broker naturally in that case with direct billing for his mediation service to the user or to the provider to transmit any incoming tenders from the health providers to the user with details of the address of this provider and of his contractual conditions, so that the user can then process the transaction further directly with the provider without going through the broker.

In principle, it would also be possible for the user to send a template-filtered inquiry directly to a marketplace, that is to say an Internet forum, to which each provider has access. In practice, however, this opportunity will frequently fail because either the providers are not interested in such independent tenders without broker filtering and therefore only a few submit tenders, or else because far too many tenders are received and the user does not have the time or the technical knowledge to check them, which means that he is ultimately again not able to make any sense of this wealth of data. The most expedient notion in practice must be an e-commerce device which involves the user contacting the multiplicity of possible providers via a broker.

In a manner which is known per se—the structure and maintenance of a personal health log has already been described in detail in a parallel application, of course—the user station is characterized by a user interface, which is protected by an authentication device, for the purpose of inputting and maintaining the data in the personal health log, this user interface being specifically intended also to be used for editing the template-generated schemes. Thus, the user does not need to adopt the templates sent to him by the broker or a user on request in unaltered form, but rather he can also make changes thereto if he is of the opinion that he prefers not to make certain very personal health data available, for example relating to previous mental illnesses or the like, so that he can limit the template's selection scheme accordingly.

The user interface can—as already described in the parallel patent application mentioned in relation to a personal health log—include a keyboard and/or interfaces to card and label readers and/or to a remote controller which, besides the card reader and the label reader, can also contain additional further input apparatuses and communication devices for the purpose of easily recording health-related data both from medical instruments and medical products. Such a remote controller is likewise described in detail in the parallel application.

### BRIEF DESCRIPTION OF THE DRAWINGS

The present invention will become more fully understood from the detailed description of preferred embodiments given hereinbelow and the accompanying drawings, which are given by way of illustration only and thus are not limitative of the present invention and in which other advantages, features and details of the invention can be found in the description below of a few exemplary embodiments and with reference to the drawings, in which:

FIG. 1 shows the schematic design of a simple, user-friendly Internet marketplace for discretion-critical transactions with health services and health products,

FIG. 2 shows a design of the user station for an inventive e-commerce device with a personal health log,

FIG. 3 shows a schematic illustration of a template database for selecting the templates for the personal health log which define the semantics of an inquiry and the scope of the data which are to be filtered out,

FIG. 4 shows a schematic illustration relating to the processing of anonymous transactions at health marketplaces and exchanges on the Internet, and

FIG. 5 shows an overall illustration of an inventive e-commerce device with a customer station, a provider station and a broker station for selectively processing direct transactions and mediated transactions.

### DETAILED DESCRIPTION OF THE PREFERRED EMBODIMENTS

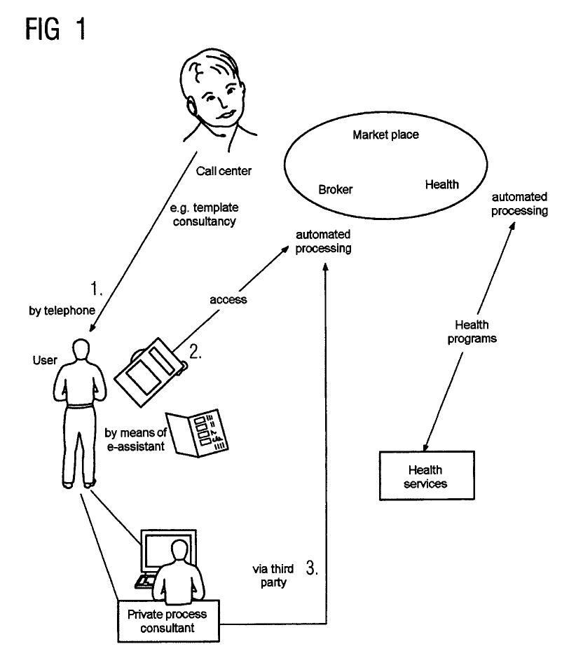

FIG. 1 shows the fundamental design of a system, which is of particularly simple design, for purchasing health services and health products in which a user is able to use a marketplace, that is to say an Internet forum or else a broker, for example, to make use of health programs from health services which in turn comprise a multiplicity of service providers and product providers on this market. The user can send inquiries to the marketplace either by telephone or using an e-assistant (remote controller), or else via a third party, in which case a call center may be of use to him in selecting the questions, so that he finds a suitable template which firstly covers the question and secondly a filter for selecting the data from his personal health log which are the sole authority for answering this question. The user's anonymous health data which have been sent with the template to the marketplace are requested by the health services, which in turn give their responses either via the marketplace, specifically when it is a broker, or else directly to the user.

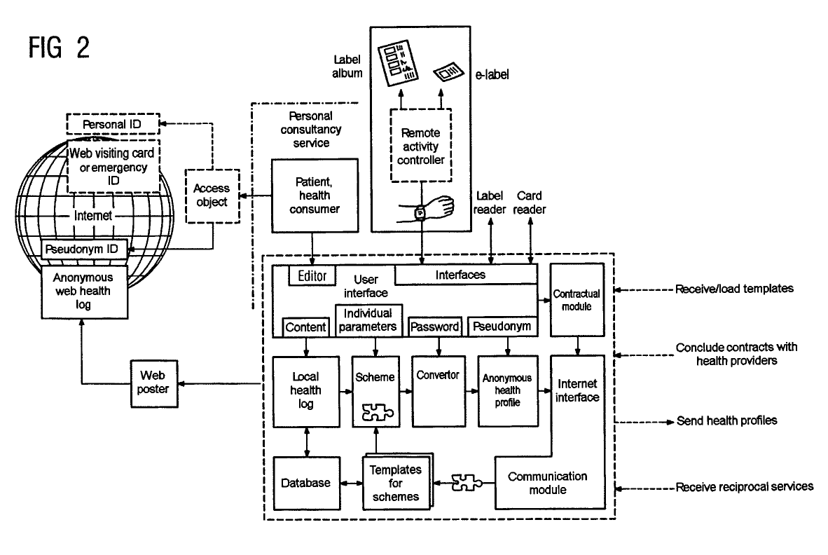

FIG. 2 shows the design of the user station, which primarily includes the personal electronic web health log which—as indicated on the left in FIG. 2—can largely also be stored anonymously on the Internet, although this is only of subordinate significance for the present application, that is to say the e-commerce device which is of interest in the present case. The design of the personal health log shown in FIG. 2 will not be described in detail at this point. Inasmuch as it has not already been revealed by the terms for the individual components, the design and maintenance of such a personal health log is described in detail in a parallel patent application.

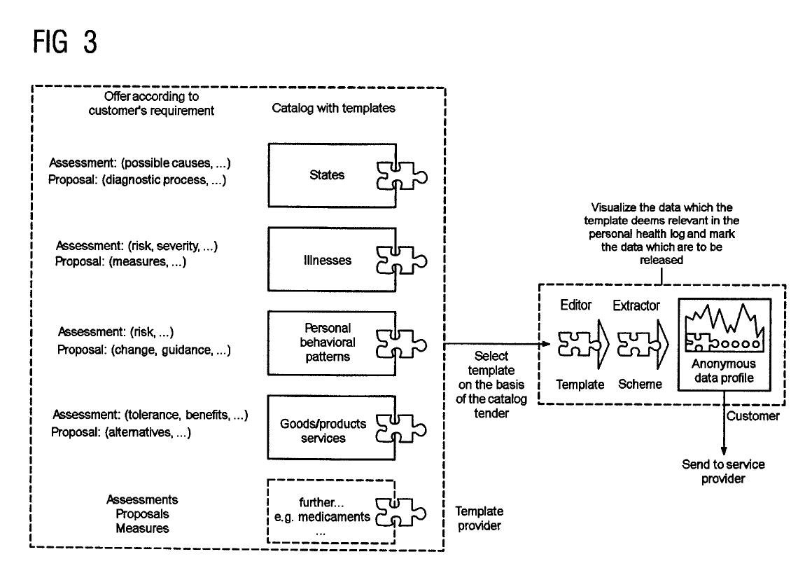

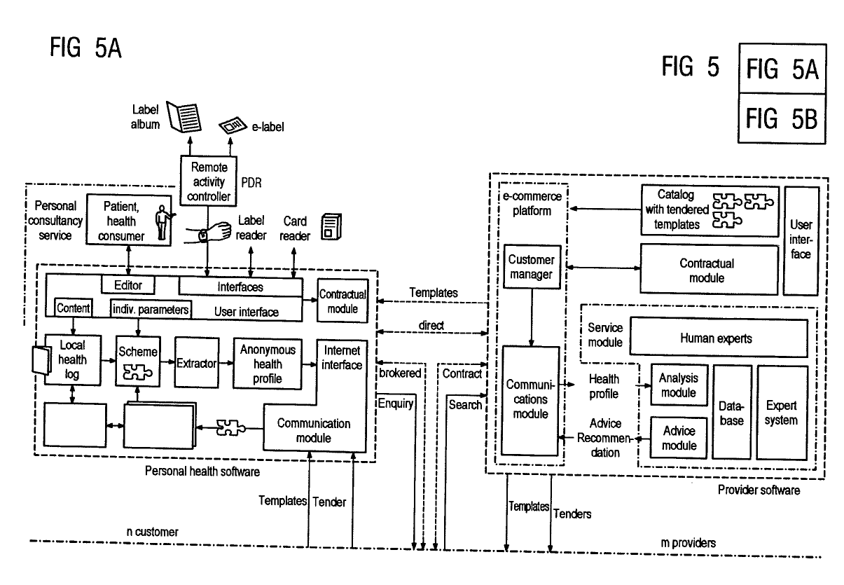

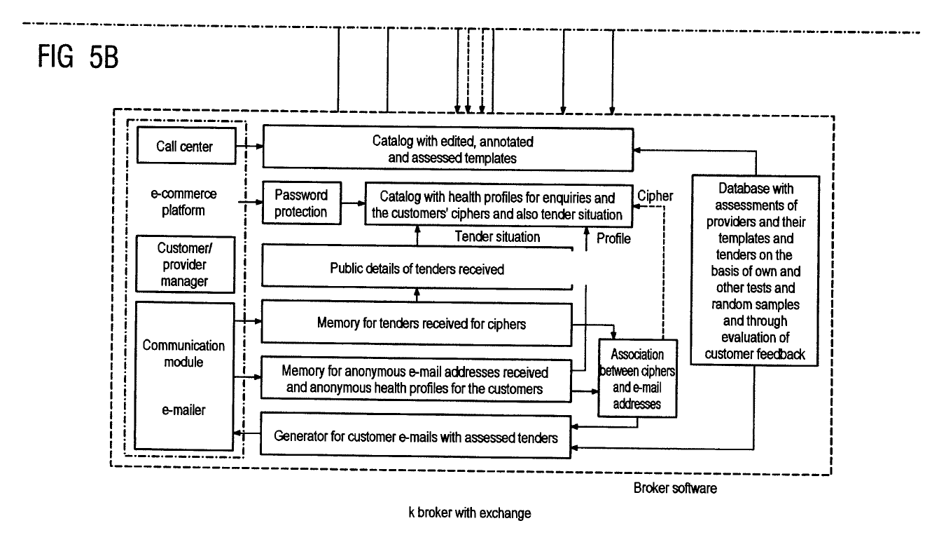

An important modification of this electronic personal health log or of the user station shown in FIG. 2 as compared with a pure health log consists in the station for receiving/loading templates which define the semantics of a health inquiry and the scope of the data which are relevant for answering such questions. These templates are ultimately nothing other than specific schemes, selected from a large template database, relating to a particular question, as indicated in FIG. 3. The user can browse for easily comprehensible criteria in a template catalog, that is to say a database belonging either to a broker or to a provider, in order to select, on the basis of his desired health question, a suitable template which he downloads and which he supplies to the extractor so that the latter selects from the local health log just the data which are required for the specific question posed, and suppresses all others. The selected data result in an anonymous health profile which is in turn transferred by the user, preferably via an Internet interface, either to a broker or directly to individual or an open number of health providers. The conclusion of contracts with health providers and the receiving of health services, which is indicated mainly schematically in FIG. 2, will be described in detail further below in connection with FIG. 5.

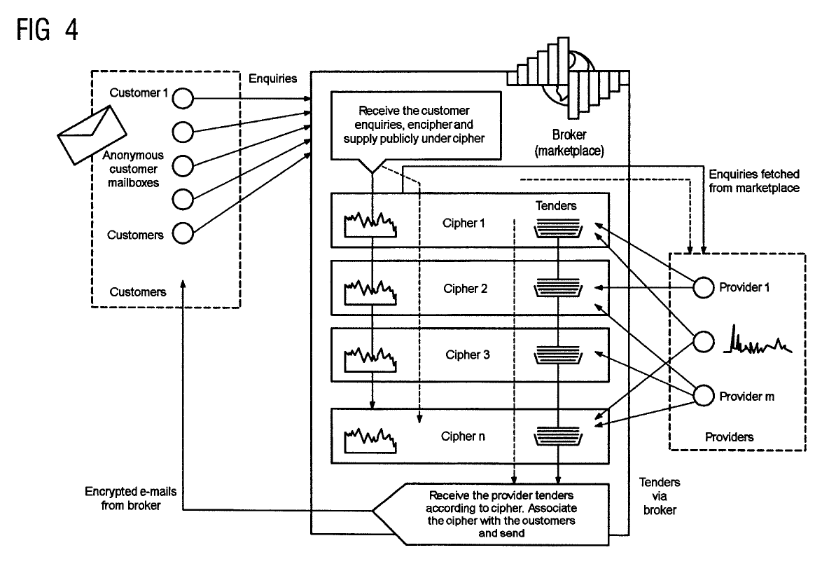

FIG. 4 shows the structure for the customer's broker (marketplace) and the totality of providers, and the interactions for such broker-mediated health services.

The multiplicity of customers send their inquiries after they have previously selected an appropriate template for such an inquiry and have downloaded it onto their computer—to the broker, who supplies the anonymous health profile to an Internet marketplace to which the many health providers have access. The enciphered inquiries are answered by the providers and are collected by the broker in appropriate memories, where they are then forwarded, following deciphering and association with the various customers, either in anonymous form, so that the customer can only contact the provider via the broker, as before, or else openly. In the latter case, the broker charges the customer for his mediation and provides him with the tender from the provider with the latter's address for further action.

FIG. 5 shows the anonymous e-health commerce system with the user station shown in FIG. 2 and also, by way of representation, a provider station and a broker station, the various possible business relations also being already indicated by corresponding arrows. The customers can deal with the multiplicity of providers via one of the brokers or else can enter into business with one of the providers directly, the type of transaction, whether mediated or direct, being able to change during the transaction. The tender can thus be fetched via the broker, and the final conclusion of the transaction can then take place directly between the customer and the provider.

The customer has schemes and templates. The fields in the tables or in the database contain health-related information about the user which is organized on the basis of the field or database structure. On the basis of generally recognized knowledge, these data can provide knowledge about the health of the patient/user, and useful behavioral measures for maintaining health or increasing health reserves can be derived. Depending on the question, some of the data is important and some unimportant in this regard, and vice versa.

The schemes defined in this case represent filters which are valid for particular questions and which positively mark the local health log's data which are important in this regard, negatively mark data which are superfluous in this regard, and note any important data which are missing. The schemes can be defined heuristically or can be derived from recognized guidelines. The user is provided with finished templates, that is to say preproduced schemes, which allow him to provide only the respective data about himself which are absolutely necessary in order to obtain a particular health service. Templates can be sorted and made available in an assessed form and developed further not just by providers of health services but also by trustworthy brokers who collect, assess and standardize templates. The templates contain definitions of the objects they contain and fields for filling in values for parameterizing the objects. One preferred implementation is the XML scheme. One particular template is the consistency check. This checks the formal conclusiveness of the details and marks obvious inconsistencies.

The schemes defined by the templates can be used by way of the extractor to generate any desired anonymous computer-readable health data profiles. The personal health data profiles form the sum of the facts from the local health log which are relevant to a health-related question as stipulated by the scheme. By way of example, the scheme can relate to questions such as: How fit am I? How high is my risk of diabetes? Am I at risk from cholesterol? etc. The extractor delivers the personal health data required for answering the question, including the associated scheme, in a form of an XML document, for example. The extractor shows the user the selected data, which means that the user is still able to remove data from the health data profile.

The health data profile is intended to allow the user to provide data in order to use outside assistance to discover his health risks and potentials for improving his health reserves. It is not primarily an object of the invention to draw conclusions locally by computer and to make diagnoses locally or to generate health advice locally, even though this would be possible to a certain degree if suitable schemes, analysis programs and advice generators are developed and provided, are purchased by the user and are then used internally by him. Such local schemes, analysis programs and advice generators need to be able to be used to point out the need for action in the case of high risks and to give advice relating to suitable further action (not shown in the figures).

The user station comprises a contractual module. This is a simple model of priced services and contains, in particular, the customer's contractual conditions relating to the permissible use of the data. In this context, a complex model of negotiated services and prices is provided which may contain a software negotiation agent which compares different tenders and can accept or submit them under auxiliary conditions. Such negotiation-oriented agents are prior art and will not be described in detail at this point.

A communication module provides the user with the opportunity to set up a connection to the Internet using the known possibility of setting up anonymous e-mail addresses and of using them to send and receive encrypted (e.g. PGP) e-mail, and of viewing Internet pages, filling in tables or downloading files. Optionally, apparatuses are provided for uploading files or for hosting them on the Internet.

The user station contains reading apparatuses for electronic labels and reading apparatuses for patient cards (health pass) from the state health systems or interfaces to such devices, and also translators for the respective data formats used for the purpose of transmitting the data to the intended places in the health log. The parallel patent application “Remote activity controller” describes a method in which the user is monitored during health-related activities and interaction with electronic labels and uses the data produced in the process. This method can advantageously be used, on the one hand, to monitor everyday habits and transfer the data automatically to the health log. On the other hand, a person with this unit, which he needs to carry, can obtain measurement data from various units, can combine them and can transfer them to the health log from time to time. This allows the instruments in a household to be used by a number of people without any association problems. The units can be produced more cheaply, since they do not have to produce any separate timestamps. The remote activity controller's contractual module is not required in conjunction with the personal health software claimed in this context, since this task is undertaken by the personal health software in this case.

It goes without saying that interfaces to the Internet are also provided by means of the communication module. In this case, if they are made accessible, it is also possible to transfer data from practice and clinic management systems and from special health service programs and to supply them to the stock of data in the health log.

Every provider station comprises an e-commerce platform. This comprises an Internet communication module which affords the opportunity to send and receive encrypted e-mails and to upload and download Internet files with a customer manager which manages the anonymous customers and the services connected to them and also with catalogs for supplying services and prices.

The provider's employees can use a user interface to operate the further components, such as template catalog, service module, contractual module and the respective submodules they contain.

A catalog with templates for the customers is provided via the e-commerce platform as a fundamental part of the inventive e-commerce device.

The system contains a service module for providers of health consultancy, health programs and products with analysis and advice modules which supply particularly effective advice and products on the basis of the analysis of the anonymous health data profiles. The analysis module compares the scheme-related health profiles with comparative profiles in the associated database and uses conclusions from an expert system. These data show one or more experts what individual advice he can give the health customer. In this case, the expert in the advice module is again supported by the database with health experience and the expert system. This results in the advice, recommendations for action, indications of risk and indications of deficiencies and gaps in the anonymous data, all of which is forwarded to the customer. The advice can range from selected highly superficial old sayings to professional accompaniment of a doctor's action based on recognized guidelines for treatment. Its quality constitutes the value of the respective provider.

Finally, the provider station naturally also comprises another contractual module, which can arrange appropriate tenders in conjunction with the customer's contractual module and can regulate the processing, particularly payment. In particular, the contractual module regulates the conditions and prices for which a health service is provided. It reacts to the agreement and disagreement of the customer's contractual agent with improved or restricted tenders. While the transactions are performed via a broker, the broker mediates the anonymous contractual communication between the customer and the provider using the cipher.

With the preferred design and operation of an e-commerce device involving health brokers as operators of a marketplace, one or more brokers are envisaged, in addition to the providers, who use exchanges (forums, marketplaces) on the Internet to develop business relations with health advisors and health providers for the individual users (health customers) and their anonymous health data. These broker stations have an ordinary e-commerce platform with a customer manager and an ordinary communication module which can be used to send and receive an e-mail and is used to host the tenders in an Internet domain. To advertise health inquiries from various health customers, a catalog is provided in which the health inquiries from anonymous customers are presented in the form of their health profiles and their contractual conditions (e.g. with a maximum price) under ciphers which have been allocated to them.

To this end, the health inquiries, received by e-mail, for example, are stored with an anonymous customer identifier (e.g. that of the e-mail address) and the health inquiry (template-related health profile and contractual data) and the customer's contractual relations. A one-off, unique cipher is formed and is allocated to the customer. This allocation is kept secret by the broker. The catalog keeps the cipher, the health inquiry including contractual conditions in public form. These data can be downloaded from the catalog by anyone wishing to make a health tender. The resultant tender is sent to the broker, indicating the cipher, the content of the tender, the price and the contractual conditions. In addition, catalogs for templates are provided in which the templates from various providers are sorted and assessed. The assessments are derived from the numbers of uses, customer feedback and test results from independent testers. For this purpose, a database is provided in which such results are entered by the broker.

Depending on the form of trade, further details about the number and quality of the tenders received can be published in the catalog (rating). If the value of the services or goods can be quantified, it is possible to use auctions or reverse bidding methods.

The association module is used by the broker to associate the tenders with the customer again and to send them to the latter together with the contractual conditions of the provider and an optionally appended assessment of the tender. In this phase, the broker is also a turntable, providing anonymity, for the contractual negotiations by computer. In return for a fee, the customer is provided with the provider's address. From then on, the customer can maintain the business relation further of his own accord.

The Internet solution claimed also provides broad options which are within the scope of desirable social contact and counteract the users' feeling of isolation on the computer. Embodiments of the invention can be used not just to trade in health-related goods and services; the same mechanisms can also be used to establish contact between people with comparable questions and comparable health problems and health experiences in the sense of self-help groups. The inventive solution affords advantages over the existing self-help groups in existing forums. Development can take place anonymously and, by virtue of the templates and health data, extremely selectively and efficiently. In this case too, anonymity can be lifted after the anonymous selection process. The people then correspond by mail or converse by telephone or meet in person.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An e-commerce device for discretion-critical transactions having a personal electronic web health log with personal health data for a user, comprising:
a data interface, adapted to be used to set up a communication link to contracting parties when required in order to transfer data to them at least intermittently from the health log, wherein a local health log is located on the computer of the user including prestructured electronic forms for inputting the personal health data;
a converter, actuated by selection schemes, including data filters, for producing encrypted data, which may be anonymous, so that they do not permit any inferences about the user's identity; and
at least one of an e-commerce platform for providers of health products and health services and a marketplace connected to the providers including a database with a multiplicity of preproduced schemes organized according to medical questions and requestable by the user, in order to transfer encrypted data, selected on the basis of a template, for the user together with the template to the providers for the purpose of submitting tenders to the user on the basis of his medical question.

2. The device as claimed in claim 1, wherein the templates are structured according to the forms in the health log.

3. The device as claimed in claim 1, wherein the template databases have a configuration device for matching the templates to the form structure in the user's health log.

4. The device as claimed in claim 2, wherein user inquiries regarding templates involve the structure of the health log also being sent.

5. The device as claimed in clam 1, wherein the user and the providers have a broker, which is independent of the latter, interposed between them for the purpose of making the requests anonymous and/or for the purpose of checking and filtering the tenders from the providers.

6. The device as claimed in claim 1, wherein a call center is arranged with at least one of the brokers the providers, for the purpose of template consultancy.

7. The device as claimed in claim 1, wherein contracting modules are included for determining the scope and for regulating the processing, including the billing, of the individual transactions between the users, brokers and providers.

8. The device as claimed in claim 1, wherein the provider stations are provided with a service module in which analysis and advice modules, in conjunction with databases and an expert system, propose particularly effective advice and products on the basis of an analysis of the anonymous health data profiles.

9. The device as claimed in claim 8, wherein the service modules contain a connection to human experts for the purpose of checking the automatically created tenders to the user.

10. The device as claimed in claim 1, wherein the broker station comprises a customer manager in order to forward inquiries from the users anonymously to at least one of particular marketplaces and providers and in order to transfer the tenders, which are preferably anonymous in terms of the provider names, to the users.

11. The device as claimed in claim 1, further comprising a user interface, protected by an authentication device, for inputting and maintaining the data in the personal health log and for editing the template-generated schemes.

12. The device as claimed in claim 11, wherein the user interface includes at least one of a keyboard, at least one interface to at least one of a card and label reader, and an interface to a remote controller.

13. The device as claimed in claim 3, wherein user inquiries regarding templates involve the structure of the health log also being sent.

14. The device as claimed in clam 2, wherein the user and the providers have a broker, which is independent of the latter, interposed between them for the purpose of making the requests anonymous and/or for the purpose of checking and filtering the tenders from the providers.

15. The device as claimed in claim 2, wherein a call center is arranged with at least one of the brokers the providers, for the purpose of template consultancy.

16. The device as claimed in claim 2, wherein contracting modules are included for determining the scope and for regulating the processing, including the billing, of the individual transactions between the users, brokers and providers.

17. The device as claimed in claim 2, wherein the provider stations are provided with a service module in which analysis and advice modules, in conjunction with databases and an expert system, propose particularly effective advice and products on the basis of an analysis of the anonymous health data profiles.

18. The device as claimed in claim 17, wherein the service modules contain a connection to human experts for the purpose of checking the automatically created tenders to the user.
